(19) United States
(12) Patent Application Publication
(10) Pub. No.: US 2010/0299486 A1
(43) Pub. Date: Nov. 25, 2010

(54) Electronic Devices and Methods for Storing Data in a Memory

(75) Inventor: Sotirios Tambouris, Munich (DE)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/771,542

(22) Filed: Apr. 30, 2010

(30) Foreign Application Priority Data
May 19, 2009 (DE) 10 2009 021 944.7

(51) Int. Cl. G06F 12/00

(52) U.S. Cl. 711/148; 711/E12.001

(57) ABSTRACT

An electronic device containing a memory having a plurality of memory modules. Each memory module includes a plurality of memory devices. The electronic device also contains a data bus having a number of lines for transferring data from and to the memory devices. The data bus is configured to have at least two sub-sets of lines coupled to different memory modules. A method including reading a data word from memory devices of different memory modules through a data bus using different subsets of lines of the data bus for each memory module.

### CROSS-REFERENCE TO RELATED APPLICATIONS

This application claims the benefit of priority under 35 U.S.C. 119 and 37 C.F.R. 1.55 to the prior-filed foreign application, German Application No. 10 2009 021 944.7, filed May 19, 2009, titled “Electronic Devices and Methods for Storing Data in a Memory”, the entirety of which is hereby incorporated by reference.

### FIELD OF THE INVENTION

The invention relates to an electronic device, a memory controller, data processing systems and methods for storing data in a memory.

### BACKGROUND OF THE INVENTION

The structure of a conventional memory of a computer system is shown in FIG. 1. The memory of conventional computer systems consists of a certain number of memory modules. These modules are usually referred to as dual inline memory modules (DIMMs). A memory channel is routed on the motherboard 3 and connected to the DIMMs via connector slots SL0 to SLn. Each DIMM0 to DIMMn consists of several memory devices DRAM0 to DRAMn (DRAM devices) and respective wires for the busses.

The memory channel consists of a clock bus (e.g. a differential CLK), an address and command bus ADD/CMD and a data bus DQ and a data strobe bus DQS. These busses are the physical connection between the memory (DRAMs on the DIMMs) and the memory controller (MC) 2.

The memory devices (DRAMs) typically have a 4 bit or 8 bit data bus width. The data bus (DQ) has a much larger bus width, for example 72 bit or 72 lines. This means that only 4 or 8 lines of the complete data bus DQ can be coupled to a single DRAM. The data bus DQ is therefore organized in subsets of lines of the complete data bus. Each subset is coupled to a DRAM on a single DIMM. The number of DRAMs on a DIMM is the data bus width divided by the data bus width of the DRAMs. This means that for example 18 DRAMs with 4 bit data bus width are required on a DIMM. The data bus DQ usually has 64 data bit and 8 bit for an error correction code (ECC). The data bus DQ is also bidirectional for reading data from the DRAMs and writing data to the DRAMs. The data bus also has a strobe signal DQS for each subset of lines of the data bus. There can be a strobe signal for each nibble (4 bits) or each byte (8 bits). The strobe signal is the synchronization signal for the corresponding subset of the data bus (i.e. the respective data bus signals on the subset of lines of the data bus) for a DRAM. The address and command bus ADDR/CMD/CTRL bus has a width of typically 28 bit or 26 bit. The difference is due to the CTRL bus portion. The address bus (ADDR) portion has a width of 16 bit <0:18>and is unidirectional. The command (CMD) bus portion has 3 bit (signals RAS, CAS, WE) and the control bus (CTRL) has 9 bit (signals CKE0/CKE1, ODT0/ODT1, CS0/CS1/CS2/CS3, PARIN). The clock signal is a differential signal CK/CKB. The clock is used for synchronizing the communication between the memory controller MC and the DRAMs. In DDR systems (Double Data Rate), the raw data is transmitted at the rising and the falling edge of the clock signal. Therefore, the ADDR/CMD signals are transmitted with half the clock frequency.

DIMMs are available in different memory sizes, for example 256 MByte and up to 1 GByte, 4 GByte or even 8 GByte. The memory size is determined through the number of DRAMs and the DRAM memory size. There are several configurations of DIMM's available which are called raw cards (RC) e.g. RC-A,B,C etc. This refers to standards relating to the number of DRAMs, their size, and the bus routings.

FIG. 1 shows a plurality of memory modules DIMM0 to DIMMn. Each memory module includes a plurality of memory devices DRAM0 to DRAM17. Connectors in respective slots provide the physical connection of the DIMMs to the motherboard. In conventional computer systems, the number of DIMM slots is limited to two per memory channel. The reason for this limitation is that the controller has to drive the data signals across the motherboard through the connectors to the memory modules DIMM0 to DIMMn and eventually to the inputs of respective memory devices DRAM0 to DRAM17. The respective memory module slots SL0 to SLn are all connected to the same bus.

The controller has to drive a huge capacitive load (DRAM inputs). The high capacitive load and various transmission line stubs entail frequency and bandwidth limitations (for example due to reflections etc.). The same problems occur for data transmitted from the memory devices DRAM0 to DRAMn to the memory controller 2. In order to overcome these problems, a second separate memory channel may be implemented. But still then, the number of slots is limited due to the structure of the computer system.

In order to overcome the physical limitations some server systems de-couple the address and command bus ADD/CMD on DIMM level from the memory controller 2. The clock signals are also buffered by a phase locked loop. However, server systems require very large memory sizes and even with the mentioned measures the available memory size and the bandwidth are insufficient.

In order to increase the memory size, DRAMs are also mounted on the back side of the DIMMs and sometimes even two DRAMs are arranged in the same package. The DRAMs are then organized in ranks. A rank can be treated as a an individual merge of DRAMs forming the complete DQ bus width (for example 72 bit) and can be selected by exclusive control signals which are included into the ADD/CMD bus (e.g. CS0,CS1=Chip Select). In order to address different DIMM slots, each DIMM slot receives an individual and separate chip select signal CSx. Only one DIMM can be addressed at the same time. For DIMMs which are not addressed, a resistive termination is switched on. The addressed DIMM has no termination except a fixed series stub termination resistor of, for example R=22 Ohms. The termination values of the unused DIMMs depend on the physical location of the active DIMM within the bus. Terminating the unused DIMM slots is unavoidable in order to preserve signal integrity. The termination values can be very low (for example 30 Ohm). This leads to high power consumption and a huge amount of heat, which requires sophisticated and also power consuming cooling systems, in particular for server system.

### SUMMARY

It is an object of the invention to provide an electronic device, a memory controller, a data processing system and various methods that may achieve higher data rates and lower power consumption than prior art solutions with respect to data transfer from and to memory devices, as for example with DRAMs.

In one embodiment, an electronic device is provided which comprises a plurality of memory modules, each of which comprises a plurality of memory devices and a data bus having a number of lines for transferring data from and to the memory devices. The data bus is configured to have at least two subsets of lines and each subset is coupled to a different memory module. This embodiment provides that the number of stubs and termination resistors can be reduced as the number of point to point connections between the memory devices and the memory controller can be increased. The memory devices are advantageously DRAM devices (for example, SDRAMs). The memory modules may be dual inline memory modules DIMM. A subset of lines may relate to a number of bits of a data word. A subset of lines may correspond to the number of bits to be written to or read from a memory device. The subset may correspond to a sequence of bits of a data word with increasing significance.

In another embodiment, more than one but not all subsets of lines are coupled to a memory module. In this embodiment, not all subsets of the lines of the data bus (i.e. the whole data bus) are coupled to the same data module. Some or all of the memory devices on a memory module may then be coupled to the respective subset of lines of the data bus.

The memory devices may be organized in groups which are configured to be enabled or disabled by configuration signals. This can be used to implement ranks of memory devices. The total memory size can then be increased as the electronic device or system benefits from the improved signal integrity of the data bus structure. The configuration signals may then be transferred to the memory devices through an address and/or command bus. Therefore, a larger number of ranks can be used. Furthermore, the configuration signals may be encoded in order to decrease the number of extra bus lines for the configuration signals. The configuration signals may be chip select signals of the memory devices.

In another embodiment, the number of memory modules can be equal to the number of memory devices on each memory module. Furthermore, the number of ranks can be equal to the number of memory modules and memory devices on each module. Still further, the configuration signals can be encoded and transferred through the command and address bus. The number of lines used for transferring the configuration signal may then be the logarithm to the basis two of the number of ranks.

A register may be provided on one or on all memory modules. The register can be coupled to an address and command bus for receiving and refreshing the address and command signals for the memory devices of the module. The register may then be configured to derive control signals for controlling the buffer for the data bus in response to received address and command signals. The register may then be configured to issue signals for switching the direction of the buffer for read and write mode.

In another embodiment, a register is provided that is configured to be arranged on a memory module. The register may then be coupled to an address and command bus. The register may comprise a decoder for decoding signals of the address and command bus for providing configuration signals to a buffer for coupling a subset of lines of a data bus having at least two subsets of lines to a memory device of a plurality of memory devices.

In another embodiment, a buffer may be provided. The buffer can be configured to be arranged on a memory module. The buffer may then be coupled to a subset of lines of a data bus comprising at least two subsets of lines. The buffer may further be configured to couple the subset of lines to a memory device of a plurality of memory devices of the memory module in response to a configuration signal. The configuration signal may be chip select signal. The configuration signal can also be received from a register. Instead of a buffer; a switch, a multiplexer, or a repeater may be provided and configured as explained for the buffer.

The electronic device may then comprise a buffer, a switch, a multi-plexer, or a repeater on a memory module for providing a point to point connection of the subset of lines of the data bus with the memory devices of the memory module. Therefore, the memory controller is also decoupled from the memory module. Furthermore, point-to-point connections may then provided on the memory module level (DIMM level), i.e. between the memory devices and a common connection to the data bus. The buffer may be a multiplexer for multiplexing the signals on the subset of lines of the data bus to the memory devices of a memory module.

In another embodiment, a data processing system has a memory which may comprise a plurality of memory modules, each of which comprises a plurality of memory devices and a data bus having a number of lines for transferring data from and to the memory devices. The data bus is configured to have at least two subsets of lines and each subset is coupled to a different memory module. The data processing system may be a server system.

In another embodiment, a memory controller can be configured to operate with a plurality of memory modules, each of which comprises a plurality of memory devices through a data bus. The data bus may have a number of lines for transferring data from and to the memory devices. The data bus can further be configured to have at least two subsets of lines and each subset is coupled to a different memory module. Furthermore, the memory controller can be adapted to issue configuration signals, as for example chip select signals, for activating ranks of memory devices or memory devices in at least two memory modules. The memory controller may also be adapted to use the configuration signals for initiating and/or performing refresh cycles of the memory devices. The memory controller may be adapted to realign the bits of the different subsets of lines of the data bus coupled to different memory modules. The memory controller may then be adapted to compensate varying time delays due to the different physical locations of the memory devices due to the arrangement in different memory modules. The memory controller may have an increased timing window for aligning data signals of different sub-sets of lines of the data bus. This is due to the large number of memory modules that can be used in this embodiment.

In another embodiment, a memory module comprises a plurality of memory devices. The memory devices of the memory module may be coupled with their data buses (i.e. their data I/O ports or I/O pins) to the same subset of lines of a data bus having more than one subset of lines. The memory module may comprise a buffer or switch or repeater for buffering the signals of the subset of lines of the data bus. The memory module may then have one or more point-to-point connections between a memory device and a common connection to the subset of lines of the data bus. The common connection may be provided by the buffer. The buffer may then be controlled with configuration signals, as for example chip select signals for the memory devices. The buffer may be configured to receive the configuration signals and to control internal switches accordingly. The buffer may also be configured to handle data strobe signals relating to the subset of data signals of the data bus transmitted through the subset of lines of the data bus.

Another embodiment provides a method of operating an electronic device comprising a plurality of memory modules, each of which comprises a plurality of memory devices and a data bus having a number of lines for transferring data from and to the memory devices. A data word may be written to memory devices of different memory modules through the data bus using different subsets of lines of the data bus for each memory module.

Another embodiment provides a method of operating an electronic device comprising a plurality of memory modules, each of which comprises a plurality of memory devices and a data bus having a number of lines for transferring data from and to the memory devices. A data word may then be read from memory devices of different memory modules through the data bus using different subsets of lines of the data bus for each memory module.

Another embodiment provides a data protocol of writing data to memory devices located on different memory modules through a data bus using different subsets of lines of the data bus for each memory module. The embodiment provides a data protocol of reading data to memory devices located on different memory modules through a data bus using different subsets of lines of the data bus for each memory module. In another embodiment, the data protocol uses configuration signals, as for example chip select signals for defining multiple ranks of memory devices, wherein a rank of memory devices is spread across multiple memory modules.

### BRIEF DESCRIPTION OF THE DRAWINGS

Further aspects of the invention will ensue from the following description of preferred embodiments of the invention with reference to the accompanying drawings, wherein:

FIG. 1 shows a memory system according to the prior art;

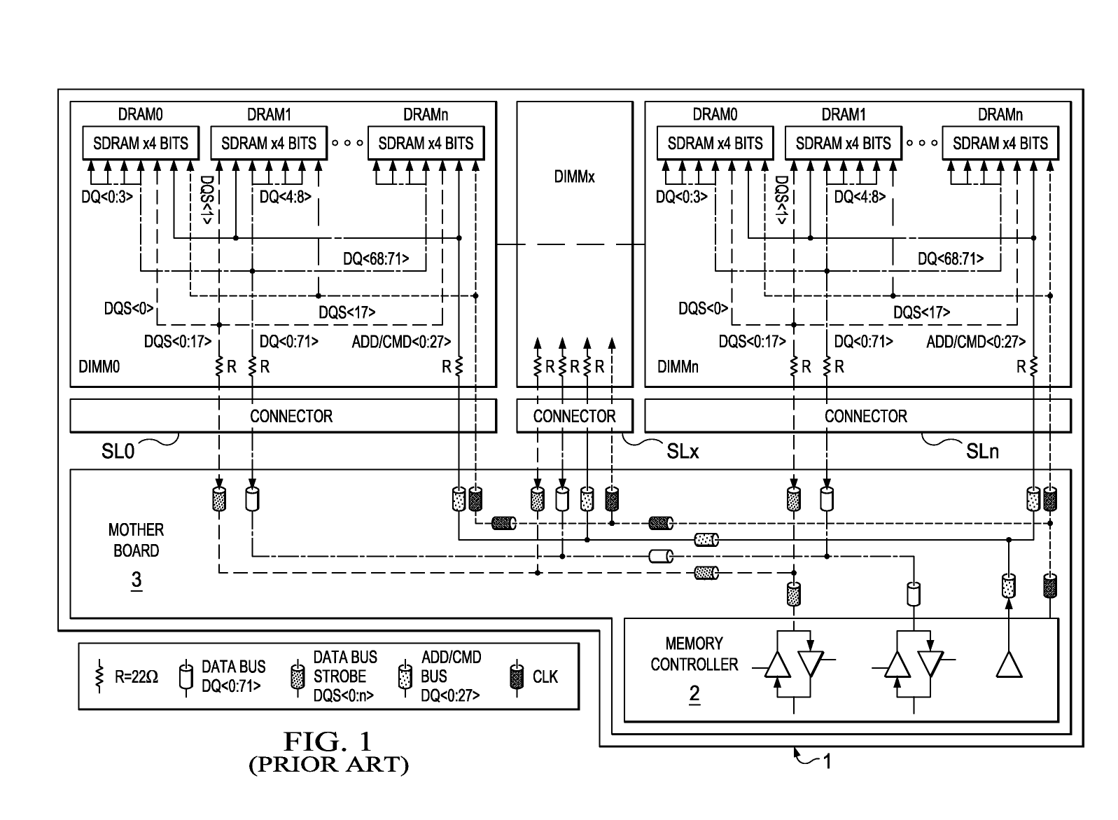

FIG. 2 shows a circuit implemented in accordance with an example embodiment;

FIG. 3 shows a circuit implemented in accordance with another example embodiment; and

FIG. 4 shows a buffer according to an example embodiment.

### DETAILED DESCRIPTION OF EXAMPLE EMBODIMENTS

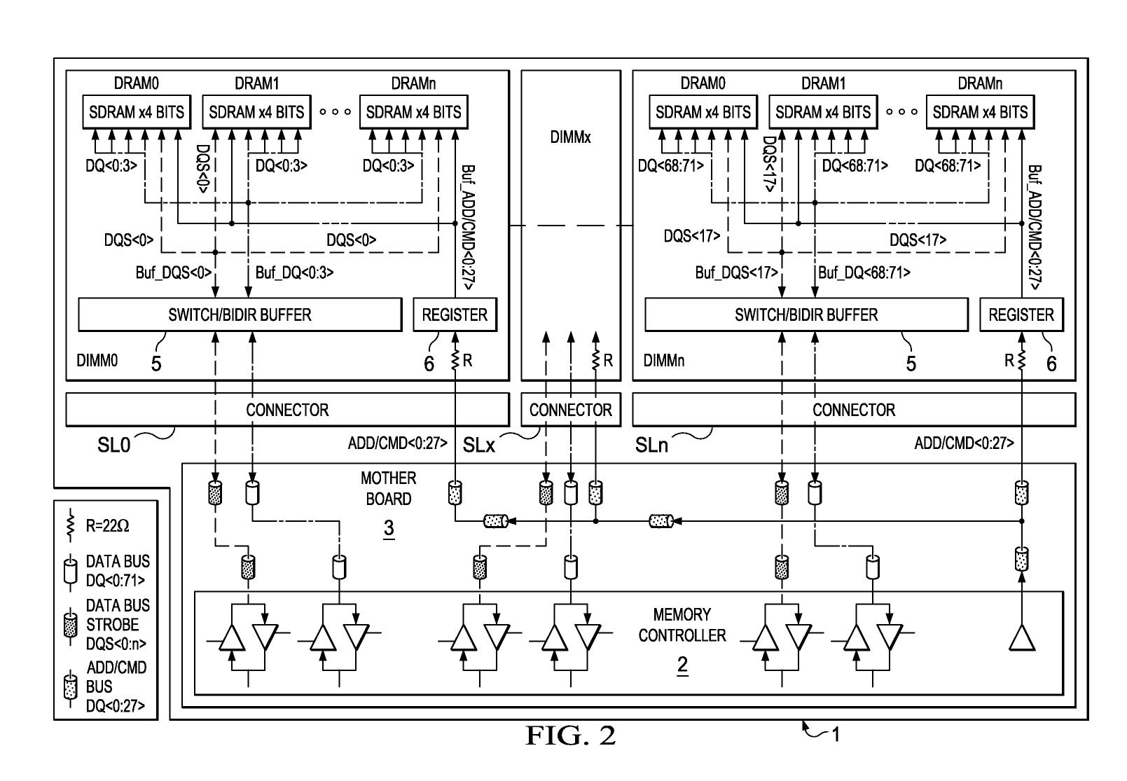

FIG. 2 shows a simplified circuit and block diagram of one embodiment. The shown electronic device 1 or data processing system comprises a memory controller 2, a mother board 3 and memory modules DIMM0 to DIMMn. The memory modules are dual inline memory modules (DIMM). Each memory module DIMM0 to DIMMn carries a plurality of memory devices DRAM0 to DRAMn. In this embodiment the number of memory devices per memory module may be 18. The number of memory modules may also be 18. This means that n can be 17. However, the number of memory devices per memory module and the total number of memory modules can also be different. The memory modules DIMM0 to DIMMn are plugged into respective slots SL1 to SLn of the mother board to be connected to a memory channel of the mother board 3. The memory channel comprises data and command busses. There is a data bus DQ<0:71>, a data bus strobe DQS<0:n>, and an address and command bus ADD/CMD<0:27>. In this embodiment, the memory devices DRAM1 to DRAMn are 4 bit SDRAMs. According to this embodiment, each of the memory modules DIMM0 to DIMMn has a common data bus DQ<×1:×2> which is a subset of the complete data bus DQ<0:71>. For memory module DIMM0, the subset of lines is DQ<0:3>, i.e. the lines of the data bus carrying the first four bits with significance 0 to 3. For memory module DIMMn, the sub-set of lines is DQ<68:71>, i.e. the lines of the data bus carrying the last four bits with significance 68 to 71. The remaining memory modules are configured to receive the remaining subsets of lines of the data bus and therefore the corresponding bits of data words. This can be done in accordance with the significance of the data bits. In this embodiment, the memory modules DIMM0 to DIMMn also have an input/output switch or input/output buffer 5 for buffering the respective subset of data bus signals DQ. Address and command bus ADD/CMD<0:27> is connected to all memory modules DIMM0 to DIMMn. Each module has an address/command register 6 for buffering and refreshing the timing of the address and command signals. Each memory module receives an individual data strobe signal, i.e. the memory module is coupled to a single line DQS<i>. In this embodiment, the bus width of the data strobe bus DQS may also be 18, in accordance with the number of modules.

In this embodiment, each memory module DIMM0 to DIMMn has a point-to-point connection with the memory controller 2. The respective part or subset of the data bus DQ is four bits wide. The number of lines of a subset of the data bus may correspond to the bit width of a memory device.

According to conventional standards, the at least four DRAM devices can be connected through a common data bus DQ to the motherboard bus routing. It is therefore possible to provide a four rank solution even without a buffer or switch 5 on each module DIMM0 to DIMMn. A maximum of two to three DIMM slots may then be used. Omitting the buffer 5 would provide that the addressable memory would be the same as for prior art implementations. However, in this embodiment, the data bus speed may be much higher since a point to point connection is established, at least between the memory modules and the memory controller. In addition, transmission line stubs may be avoided. Also the power dissipation may be reduced. In terms of memory size there may be no difference to the prior art solution.

By dividing the DQ bus into subsets, each of which is used for an individual memory module of a plurality of memory modules DIMM0 to DIMMn, the memory controller 2 has to cope with only a single input load. There is only a point to point connection of, for example 4 bit or 8 bit DQ signals. The memory controller 2 can then be configured to handle the new configuration. The bus drivers may even be reduced for very low power solutions. Furthermore, each subset of the data bus DQ may now have an individual delay, impedance, or other characteristic. The memory controller may then be configured to adapt the bus drivers to the new data bus structure. The signal integrity of the DQ bus may be improved as only point-to-point connections are used and parasitic capacitances may be removed. The power consumption of the whole electronic device or data processing system may be reduced as the unused DIMM slots do not have to be terminated. Only one memory device DRAM0 to DRAMn can be active in each memory module DIMM0 to DIMMn. Furthermore, power dissipation and therefore heat generation may be distributed over a greater area or space, since only one (or only a few) memory device DRAM0 to DRAMn may be used on each memory module DIMM0 to DIMMn at the same time. This may allow the use of a low performance and cheaper cooling system, which may provide an additional reduction of power consumption.

If only a single rank is implemented, this embodiment may allow higher data bandwidth and higher speed as well as lower power consumption. In addition, the amount of total addressable memory can be increased with this embodiment.

The embodiment in FIG. 2 may comprise memory modules with eighteen 4 bit DRAMs (including error correction code (ECC)). In order to match the complete data bus DQ<0:71> eighteen DIMM slots are required. A single memory device DRAM0 to DRAM18 (n=18) is used on each DIMM at the same time. This corresponds to a single rank.

In another embodiment, the number of addressable ranks may be much higher. For example, the number of addressable ranks may be eighteen (2 DIMMs are used for ECC=8bit=2xnibbles). This embodiment is illustrated in following TABLES 1 to 3.

TABLE 1
RANK0 (CS0 = 1, CSx = 0)

| DIMM | DIMM0 | DIMMx | DIMMn − 1 | DIMMn |
|---|---|---|---|---|
| DRAM | DRAM0 | DRAM0 [0:3] | DRAM0 [0:3] | DRAM0 [0:3] |
| | [0:3] | | | |
| DQ | DQ[0:3] | DQ[x:x + 3] | DQ[64:67] | DQ[68:71] |

The remaining memory device DRAMs on each memory module DIMM0 to DIMMn, may be addressed in a similar way and 17 additional ranks can be achieved:

TABLE 2
RANK1 (CS1 = 1, CSx = 0)

| DIMM | DIMM0 | DIMMx | DIMMn − 1 | DIMMn |
|---|---|---|---|---|
| DRAM | DRAM1 [0:3] | DRAM1 | DRAM1 [0:3] | DRAM1 [0:3] |
| | | [0:3] | | |
| DQ | DQ[0:3] | DQ[x:x + 3] | DQ[64:67] | DQ[68:71] |

TABLE 3
RANK18 (CS18 = 1, CSx = 0)

| DIMM | DIMM0 | DIMMx | DIMMn − 1 | DIMMn |
|---|---|---|---|---|
| DRAM | DRAM18 | DRAM18 [0:3] | DRAM18 [0:3] | DRAM18 [0:3] |
| | [0:3] | | | |
| DQ | DQ[0:3] | DQ[x:x + 3] | DQ[64:67] | DQ[68:71] |

TABLE 1 shows the situation for the first rank RANK0. The bus structure of the data bus is as previously described and in accordance with one embodiment. However, rank RANK0 only addresses the memory devices with reference number 0, i.e. memory devices DRAM0. This is achieved with chip select signals. The respective chip select signal CS0 for the first rank RANK0 is active and the other chip select signals CSx are all zero. The chip select signals CS0 to CS18 are not shown as individual lines for each DIMM slot. They may be part of the address and command bus ADD/CMD bus. TABLE 2 relates to another rank RANK1. Therefore, chip select signal CS1 is active and the corresponding memory devices DRAM1 on the respective modules DIMM0 to DIMM18 are used. TABLE 3 shows the situation for the last rank RANK18. Chip select signal CS18 is now set to logic high for activating the memory devices DRAM18 on the memory modules. With this embodiment, an increase of the addressable number of ranks may be achieved, possibly without degrading the signal integrity and possibly without simultaneously increasing the load.

In an embodiment with more than a single rank, the bidirectional buffer or switch 5 on each memory module DIMM0 to DIMMn may be necessary (it may also be a repeater). The repeater/switch/buffer 5 may be a bidirectional buffer with an input and output stage for refreshing the signal and providing the necessary driving capability, or it can be a simple switch without signal regeneration.

If a repeater or buffer 5 is used, the address and command bus ADD/CMD can be modified in order to carry signals for switching the direction of the data bus DQ dependent on the mode: READ or WRITE. The ADD/CMD register 6 may then be extended by this function as the READ/WRITE mode information is usually included in the address and command bus signals.

The device 5 may be a five bit wide 1-to-1 connector. The inputs and outputs of the memory devices DRAM0 to DRAMn are then connected to a common 4 bit DQ bus (a subset of the data bus DQ) and a common 1 bit subset of the data strobe bus DQS (all signals share a common bus). The switch/repeater/buffer 5 forms the interface to the motherboard 3.

The memory devices DRAM0 to DRAMn, which are not used (unselected ranks) may be set to a high impedance state (tristate). Therefore, these memory devices do not interfere with the real data transported from/to active memory devices DRAM0 to DRAMn on the active memory moduels DIMM0 to DIMMn. The rank selection is performed through the chip select signals (CS0 to CSn) transferred through the address and command bus ADD/CMD. In an embodiment, the same number of CS signals or lines may be provided as the number of ranks. However, in another embodiment, the necessary CS signals may be encoded by the memory controller 2 in order to save routing effort. In this case the ADD/CMD register 6 can be configured to decode the CS signals and provide the real CS signals to the DRAMS and the buffer device. A coding scheme may be binary, i.e. y=log2 n, with n being the number of ranks and y the number of required bits and/or separate lines. For 16 ranks, at least four bits or four lines are required.

The chip select signals may then also be used for refreshing unused memory devices DRAM0 to DRAMn. The respective DRAM refresh may then be initiated through the address and command bus ADD/CMD and the chip select signal CSx. The memory controller can then be adapted in order to control the refresh cycles.

In still another embodiment, additional ranks may be included within a memory module DIMM0 to DIMMn. For example, several rows of DRAMs (front and/or backside) on the DIMM may be used, in order to increase the number of ranks. As the memory modules DIMM0 to DIMMn are spread over the motherboard 3, the flight time of each DQ nibble (4 Bit) and DQS (1 Bit) depends on the DIMM location. The memory controller 2 has to realign these DQ nibbles in order to receive all 72 bits of the DQs at the same time. Although this mechanism is to certain extent already incorporated in conventional memory controllers, a memory controller according to this embodiment has an adapted timing window alignment with respect to the increased number of memory modules DIMM0 to DIMMn.

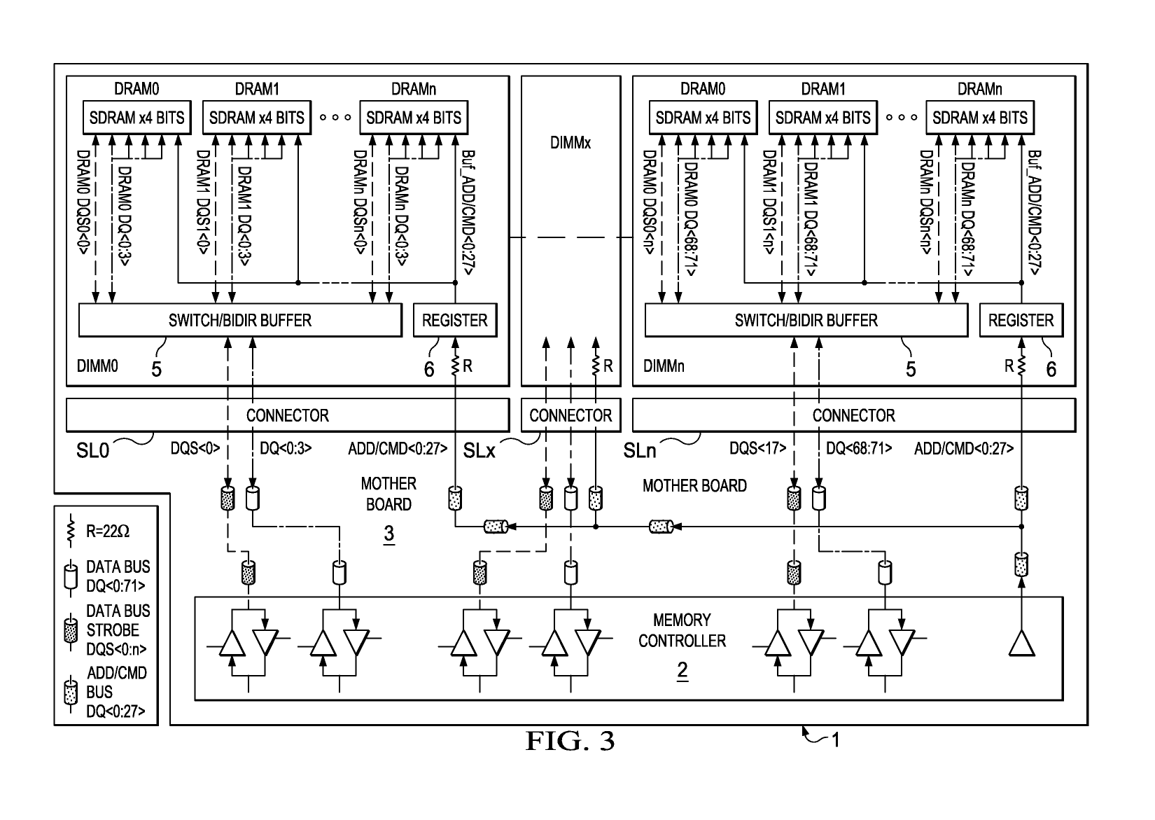

FIG. 3 shows a simplified circuit and block diagram of another embodiment. The main structure of the electronic device 1 is similar to FIG. 2. However, in this embodiment, each memory module DIMM0 to DIMMn has a point-to-point connection between each of the memory devices DRAM0 to DRAMn and a connecting point, where the point-to-point connections of the memory module are coupled to a respective subset of lines of the bus DQ. In this embodiment, this is implemented with the switch or device 5. The device 5 provides a separate port for each memory device DRAM0 to DRAMn on the modules.

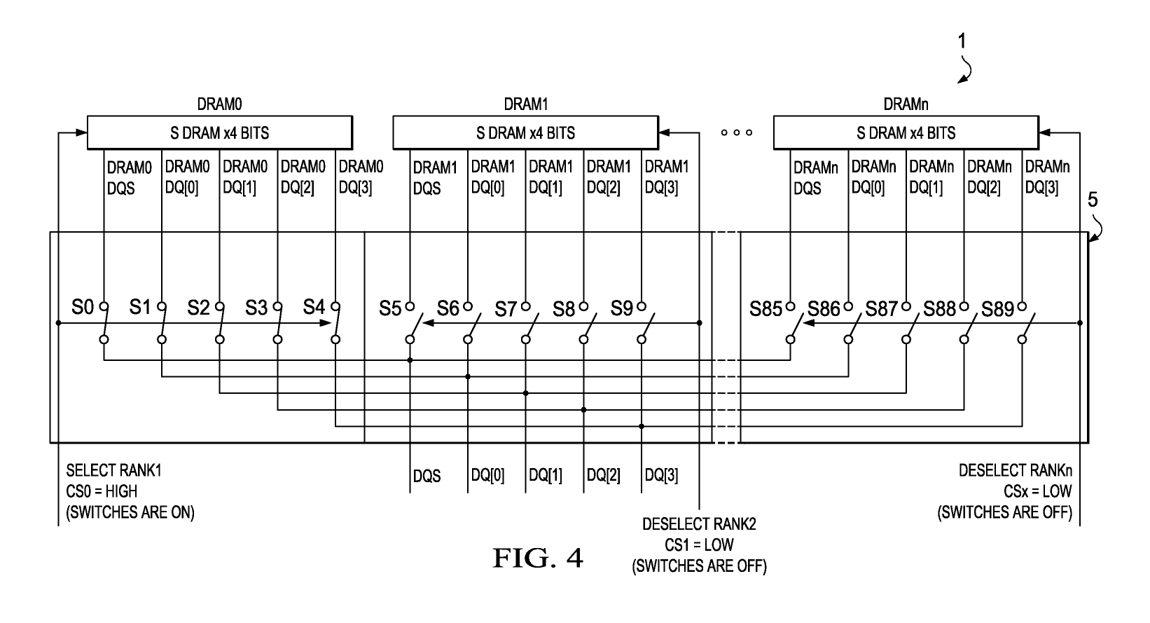

FIG. 4 shows a simplified circuit and block diagram of an example buffer 5 for use in the circuit 1 (such as the circuit 1 shown in FIGS. 2 and 3) according to an embodiment. For each of the memory devices DRAM0 to DRAMn the buffer 5 provides a separate port for the subset of signals of the data bus and the strobe signal. With this buffer 5, the four bit wide DQ bus and the one bit wide DQS signals can be separately routed from the buffer 5 to the memory devices DRAM0 to DRAMn. Therefore, each memory module of the whole system 1 has a real point to point connection. The point-to-point connection is now provided on the level of the memory module. This may further reduce the loading and may also improve signal integrity, thus leading to a higher possible data rate. The buffer shown in FIG. 4 may comprise a 5 bit “1 to 18 multiplexer”. There are basically ninety switches S0 to S89, which are controlled with the chip select signals CS0 to CSn. Furthermore, for a bidirectional buffer, control signals and/or additional switches for the opposite direction may be added. This architecture may provide device area and cost savings.

If the device 5 is implemented with a multiplexer than it is inherently bi-directional. Therefore, signals for setting the direction of the buffer (for READ or WRITE data transfers) are not required. The chip select signals CSx may be fed into the buffer 5 and used for controlling the switches. The same chip select signals may be connected to the DRAM's.

Although the invention has been described hereinabove with reference to specific embodiments, it is not limited to these embodiments and no doubt further alternatives will occur to the skilled person that lie within the scope of the invention as claimed.

What is claimed is:

1. An electronic device, comprising:
a plurality of memory modules, each of the plurality of memory modules having a plurality of memory devices; and
a data bus coupled to the plurality of memory modules, each data bus having a number of lines for transferring data from and to the plurality of memory devices;
wherein the data bus is configured to have at least two subsets of lines that are coupled to different memory modules of the plurality of memory modules.

2. The electronic device according to claim 1, wherein the plurality of memory devices are organized in ranks, and each of the plurality of memory devices of a same rank are located on the different memory modules of the plurality of memory modules.

3. The electronic device according to claim 2, wherein a number of the ranks is equal to a number of the plurality of memory devices on each of the plurality of memory modules.

4. The electronic device according to claim 1, wherein a number of the plurality of memory modules is equal to a number of the plurality of memory devices on each of the plurality of memory modules.

5. The electronic device according to anyone of claims 2, wherein the memory devices of the same rank are configured to be enabled or disabled by a single configuration signal and the single configuration signal is transferred to the plurality of memory devices through an address and/or command bus.

6. The electronic device according to claim 1, further comprising a buffer on one of the plurality of memory modules, the buffer being configured to provide a point to point connection between the at least two subset of lines of the data bus and each of the plurality of memory devices of the one of the plurality of memory modules.

7. The electronic device according to claim 1, further comprising a memory controller coupled to the plurality of memory modules.

8. The electronic device according to claim 2, wherein unused ranks are set to a high impedance state.

9. A memory module, comprising:
a plurality of memory devices; and
a switch coupled to the plurality of memory devices, the switch configured to provide a separate port for each of the plurality of memory devices.

10. A method of operating an electronic device, comprising:
writing a data word to memory devices of different memory modules through a data bus, wherein different subsets of lines of the data bus are used for each of the different memory modules.

11. A method of operating an electronic device, comprising:
reading a data word from memory devices of different memory modules through a data bus, wherein different subsets of lines of the data bus are used for each of the different memory modules.
